(19) United States
(12) Patent Application Publication
(10) Pub. No.: US 2014/0122347 A1
(43) Pub. Date: May 1, 2014

(54) System for Life-Cycle Tracking of Recycle Commodities

(71) Applicant: BNSF LOGISTICS, Springdale, AR (US)

(72) Inventors: Andrew Moran, Fayetteville, AR (US); Frank Armstrong, Rogers, AR (US); Lorne Campbell, Huntsville, AR (US)

(73) Assignee: BNSF LOGISTICS, Springdale, AR (US)

(21) Appl. No.: 13/666,568

(22) Filed: Nov. 1, 2012

(51) Int. Cl. G06Q 10/00

(52) U.S. Cl. 705/308

(57) ABSTRACT

A system for life-cycle tracking of recycle commodities providing a multitude of users with real-time tracking and accounting data related to the progress of recycle commodities from bundling of the recycle commodities at a waste generator, through consolidation of the recycle commodities, and then finally the selling of the recycle commodities from the waste generator directly to a recycler.

### BACKGROUND

1. Field of the Invention

The present invention relates in general to the field of recycle commodities and their relationship between producers or waste generators and recyclers.

2. Description of Related Art

Due to the ever present need to lower costs and reduce overhead, waste generators are finding new ways of increasing economic efficiency. One of the ways to reduce overhead is by lowering the amount of material sent to landfills. Another way to reduce overhead is to generate revenue from materials that would otherwise be thrown away. Currently, retailers produce a variety of waste products including trash, paper, cardboard, plastics, oils and organic waste, tires, etc. Some of those waste products are liabilities and some are assets. Because of the growing costs of raw materials the value of waste products will continue to rise.

Referring to FIG. 1 in the drawings, a flow chart of the recycle materials according to the current practices in the industry is illustrated. Retailer A 101 produces a variety of recycle materials 105 that the retailer A 101 must deal with. Those recycle materials 105 may be an asset or a liability depending upon if the material has any value. Some of the recycle materials 105 that may be assets include paper products 111, cardboard products 115, plastics 121, oils and organic wastes 125, and tires 131. These products have value to recyclers as materials to be recycled and made into raw materials.

When retailer A 101 generates the recycle material 105, the retailer A 101 does a preliminary sort operation to group like materials. Generally, there is a paper group 111, a cardboard group 115, a plastics group 121, an oils and organic wastes group 125, and a tire group 131. Once sorted a recycler sends a truck on a regular schedule to pick up the recycle material 105. In some cases recycler A may pick up 141 multiple types of materials like paper 111 and cardboard 115. Or there are three different recyclers picking up separately 145 for three different group such as plastics 121, oils and organic waste 125, and tires 131. While the figure is illustrated with Retailer A 101, it should be apparent that any number of waste generators are capable of producing waste streams that are valuable such as manufacturers, schools, distributors, hospitals, government facilities, Retailer A 101 was shown for simplicity.

After pick up the four different recyclers take the recycle materials 105 to their respective recycling facilities and drop them off 151. At this point in the cycle the recycle materials 105 are weighed 161. Once the recycle materials 105 are weighed the recycler then processes 171 the recycle materials dependent upon the type of recycle material and the condition the recycle material is in. The retailer A 101 is provided with revenue or credits based upon the weight of the materials, the type of materials, and the condition of the materials. It should be apparent that recyclers might weigh the materials after some type of processing has occurred.

There are inherent issues with the current system. First, the retailer has little or no transparency to the process once the materials are picked up 141 or 145. This results because the retailers are not equipped to accurately weigh the recycle materials 105 as they leave the loading docks of the retailers. The retailers have the ability to count the cubes or bails of cardboard and so many tires, but considering that the weights of materials vary the ability to accurately measure what is picked up is not likely. Second, the recyclers have little or no incentive to accurately record what is picked up. Since the recyclers have to pay the retailers for what they picked up, if the loads are lighter or there are less of them then the recyclers generate a greater profit. This incentive by the recyclers when combined with the retailer's lack of being able to weigh what leaves the dock creates a potential for fraud. Finally, retailers are plagued with a variety of recyclers, each of them picking up valuable materials from the retailers. Gathering information from the different recyclers about how much was picked up, where it is was picked up from, and when it was picked up from is difficult. Current system produce feedback to the retailers or waste generator nearly 60-90 days after the recycle material has been picked up from the facility. This delay prohibits retailers from determining the effectiveness of the new business plans to reduce waste and increase recycling.

Thus, there exists significant room for improvement in the art for overcoming these and other shortcomings of conventional systems for tracking of recycle commodities.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flow chart of the recycle materials according to the current practices in the industry;

FIG. 2A is a flow chart of the alternative embodiment of the system for life-cycle tracking of recycle commodities according to the present application;

FIG. 2B is a flow chart of an alternative embodiment of the system for life-cycle tracking of recycle commodities according to the present application;

FIG. 3 is a flow chart of an alternative embodiment of the system for life-cycle tracking of recycle commodities according to the present application;

FIG. 4 is a flow chart of an alternative embodiment of the system for life-cycle tracking of recycle commodities according to the present application;

FIG. 5 is a flow chart of the preferred embodiment of the system for life-cycle tracking of recycle commodities according to the present application; and

FIG. 6 is a flow chart of the preferred embodiment of the management system according to the present application.

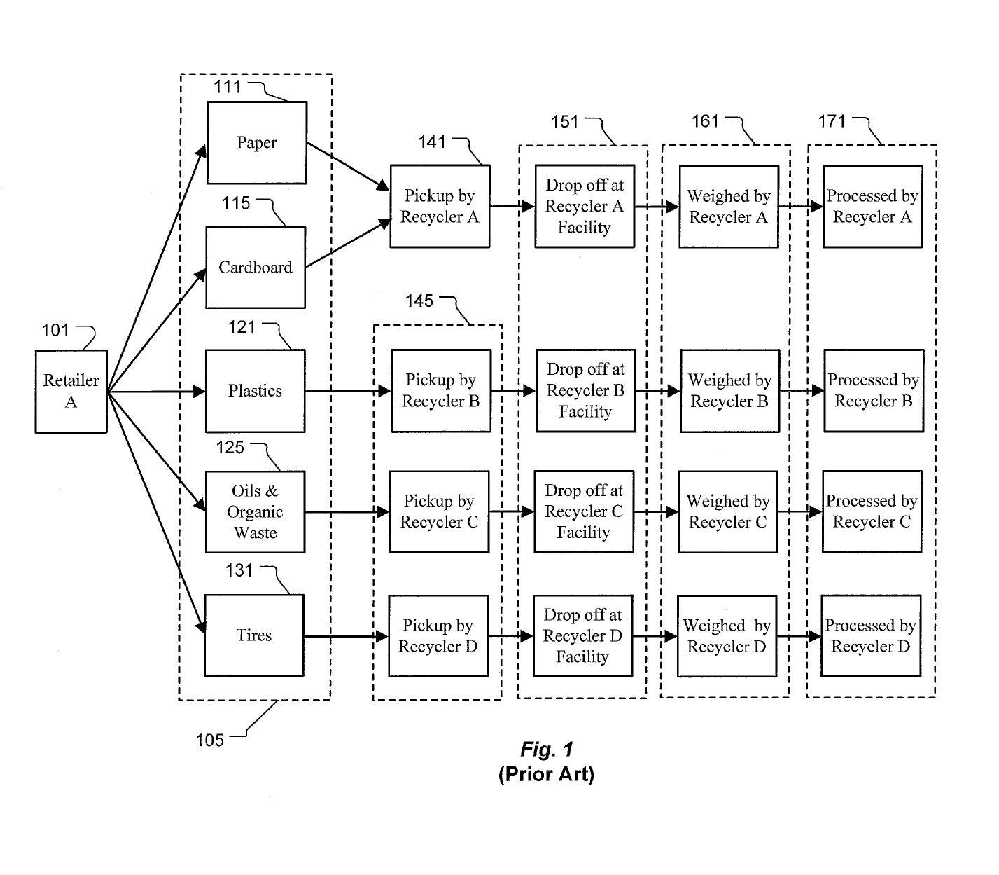

While the system of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system for life-cycle tracking of recycle commodities are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

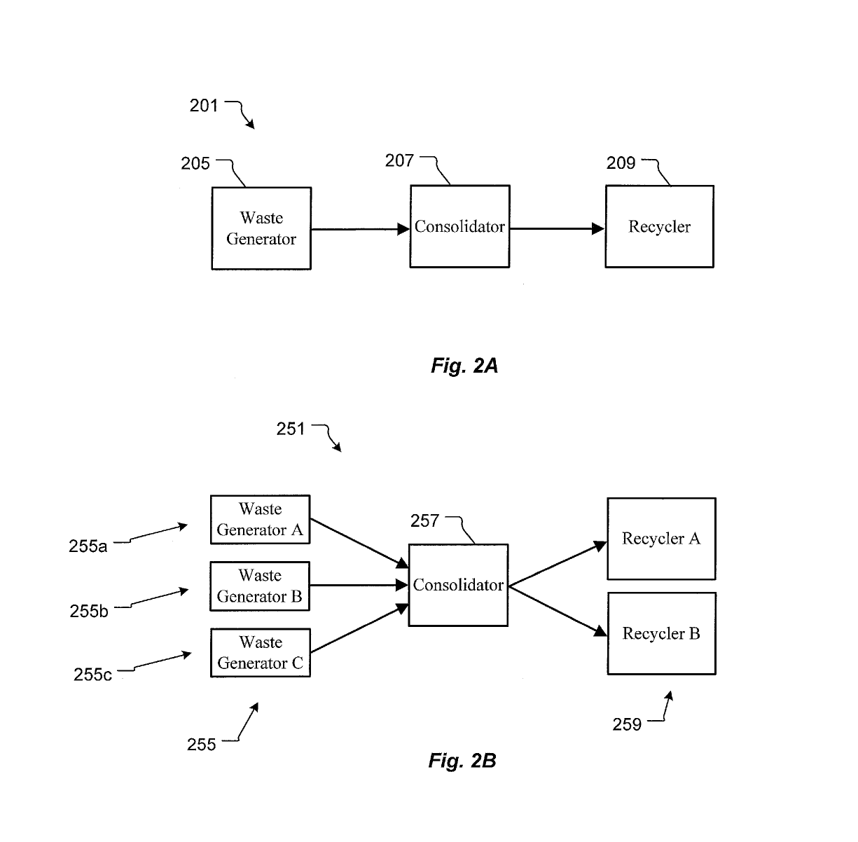

Referring now also to FIG. 2A in the drawings, an alternative embodiment of a system for life-cycle tracking of recycle commodities according to the present application is illustrated. The system 201 comprises a waste generator 205, a consolidator 207, and recycler 209. The life-cycle of recycle commodities or recycle materials is from their creation at a waste generator 205 till they are recycled by the recycler 209.

The waste generator as a result of business generates materials that they no longer want. Some of the generated material has value and some has a cost associated with disposal. The materials generated by the waste generator 205 that have a value must be removed from the store, transported to those that are interested in buying them. Because the materials have value they need to be tracked and accounted for, while reducing fraud and theft.

In system 201 the consolidator 207 is responsible for removing the recycle materials from the waste generator 205. Once the recycle material is removed from the waste generator 205 by the consolidator 207, the recycle material is transported to the recycler 209. The recycler 209 purchases the recycle materials from the waste generator 205. Because the consolidator does not purchase the recycle material from the waste generator there is no inducements for the consolidator to lose recycle materials.

Consolidator 207 provides tracking and accountability to the waste generator 205 for their recycle materials.

Referring now also to FIG. 2B in the drawings, an alternative embodiment of a system for life-cycle tracking of recycle commodities according to the present application is illustrated. The system 251 comprises waste generators 255, a consolidator 257, and recyclers 259.

Waste generators 255 as a result of business generate materials that they no long want. Some of the generated material has value and some has a cost associated with disposal. The materials generated by the waste generators 255 that have a value, the recycle materials, must be removed from the store, transported to recyclers 259 that are interested in buying them. Because the recycle materials have value they need to be tracked and accounted for which in turn reduces fraud and theft.

In system 251 the consolidator 207 is responsible for removing the recycle materials from the waste generators 255. Waste generators 255 comprises a single waste generator with multiple facilities such as Waste generator A 255a, Waste generator B 255b, and Waste generator C 255c. It should be apparent that waste generators 255 could be a multitude of different enterprises with a variety of locations. Once the recycle material is removed from the waste generators 255 by the consolidator 257, the recycle material is transported to the recyclers 259. The recyclers 259 purchases the recycle materials from the waste generators 255. Because the consolidator does not purchase the recycle material from the waste generators 255 there are no inducements for the consolidator 257 to lose recycle materials. Consolidator 257 provides tracking and accountability to the waste generators 255 for their recycle materials. Recyclers 259 comprises multiple recyclers such as Recycler A 259a and Recycler B 259b. It should be apparent that there might be any number of different recyclers, each of whom is interested in buying a portion of the recycle materials the waste generators 255 produce. Additionally, the consolidator 257 is capable of providing tracking and accounting for the recycle materials from each of the specific stores in the waste generators 255 throughout the system 251 until the recycle material reaches the recyclers 259. Consolidator 257 is able to provide tracking and accounting for the recycle materials to the waste generators 255 as to which of the specific recyclers the recycle material went to.

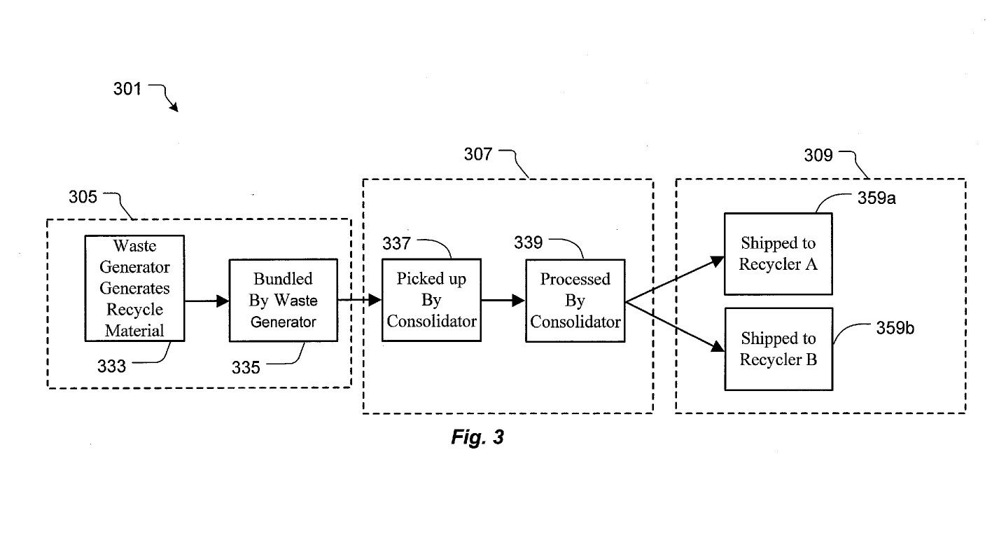

Referring now also to FIG. 3 in the drawings, an alternative embodiment of a system for life-cycle tracking of recycle commodities according to the present application is illustrated. The system 301 comprises waste generator 305, a consolidator 307, and recyclers 309.

Waste generator 305 as a result of business generates materials that they no longer want 333. Some of the generated material has value and some has a cost associated with disposal. The materials generated by the waste generators 305 that have a value, the recycle materials, must be removed from the facility, transported to recyclers 309 that are interested in buying them. Because the recycle materials have value they need to be tracked and accounted for which in turn reduces fraud and theft.

In system 301 the consolidator 307 is responsible for removing the recycle materials from the waste generator 305. It should be apparent that waste generator 305 could be a multitude of different waste generators with a variety of locations however only one waste generator is shown for clarity. Waste generator 305 is responsible for bundling 335 like recycle materials together. Since the waste generator 305 has the ability to sort the material as they are created, the waste generator 305 can easily sort the recycle material based upon the type of recycle material. Consolidator 307 picks up 337 the bundled 335 recycle material from the waste generator 305. The consolidator 307 processes 339 the recycle materials for the waste generator 305. After processing 339 the consolidator ships the recycle material to the recyclers 309. The recyclers 309 purchases the recycle materials from the waste generators 305. Because the consolidator 307 does not purchase the recycle material from the waste generators 305 there are no inducements for the consolidator 307 to lose recycle materials. While processing 339 consolidator 307 provides tracking and accountability to the waste generators 305 for their recycle materials. Recyclers 309 comprises multiple recyclers such as Recycler A 359a and Recycler B 359b. It should be apparent that there might be any number of different recyclers, each of whom is interested in buying a portion of the recycle materials the waste generators 305 produce. Recycler A 359a may only be interested in purchasing the cardboard recycle material and recycler B 359b may only be interested in buying the plastic recycle material. Additionally, the consolidator 307 is capable of providing tracking and accounting for the recycle materials from each of the specific facilities of the waste generators 305 throughout the system 301 until the recycle material reaches the recyclers 309. Consolidator 307 is able to provide tracking and accounting for the recycle materials to the waste generators 305 as to which of the specific recyclers the recycle material went to.

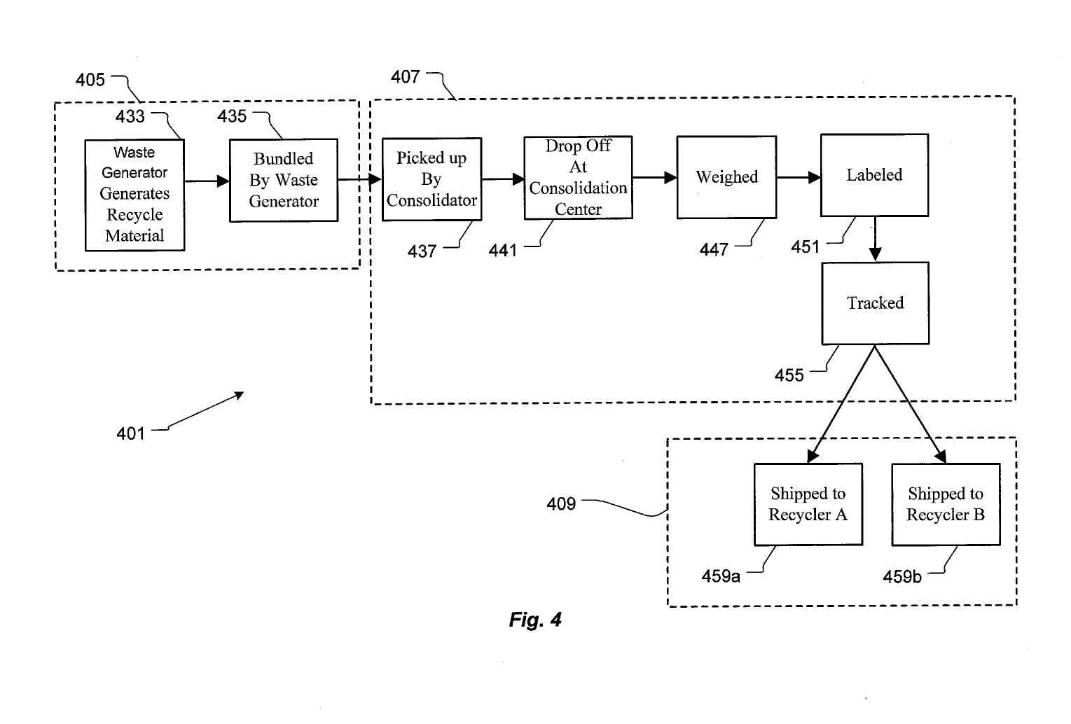

Referring now also to FIG. 4 in the drawings, an alternative embodiment of a system for life-cycle tracking of recycle commodities according to the present application is illustrated. System 401 comprises a waste generator 405, a consolidator 407, and recyclers 409.

Waste generator 405 as a result of business generates materials that they no long want 433. Some of the generated material has value and some has a cost associated with disposal. The materials generated by the waste generator 405 that have a value, the recycle materials, must be removed from the store, transported to recyclers 409 that are interested in buying them. Because the recycle materials have value they need to be tracked and accounted for which in turn reduces fraud and theft.

In system 401 the consolidator 407 is responsible for removing the recycle materials from the waste generator 405. It should be apparent that waste generator 405 could be a multitude of different waste generators with a variety of locations however only one waste generator 405 is shown for clarity. Waste generator 405 is responsible for bundling 435 like recycle materials together. Since the waste generator 405 has the ability to sort the material as they are created, waste generator 405 can easily sort the recycle material based upon the type of recycle material.

Consolidator 407 picks up 437 the bundled recycle material from the waste generator 405. The consolidator 407 processes the recycle materials for the waste generator 405. Processing the recycle material for the waste generator includes delivering the recycle material to a consolidation center 441. At the consolidation center the recycle material is weighed as it is unloaded 447. Once weighed the recycle material is labeled 451. Labeling the recycle material allows the consolidator 407 to be able to track each bundle of recycle materials 455. Labeling 407 and tracking 455 consists of providing each bundle of recycle material with a unique identifier so that the bundle of recycle material can be traced from the waste generator's facility through the consolidator's facility and finally till it reaches the recycler's facility.

After tracking 455 the consolidator 407 ships the recycle material to the recyclers 409. The recyclers 409 purchase the recycle materials from the waste generators 405. Because the consolidator 407 does not purchase the recycle material from the waste generators 405 there are no inducements for the consolidator 407 to lose recycle materials. While processing the recycle material the consolidator 407 provides tracking and accountability to the waste generators 405 for their recycle materials. Recyclers 409 can comprise multiple recyclers such as Recycler A 459a and Recycler B 459b. It should be apparent that there might be any number of different recyclers, each of whom is interested in buying a portion of the recycle materials the waste generator 405 produce. Recycler A 459a may only be interested in purchasing the paper recycle material and recycler B 459b may only be interested in buying the tire recycle material. Additionally, the consolidator 407 is capable of providing tracking and accounting for the recycle materials from each of the specific stores in the waste generators 405 throughout the system 401 until the recycle material reaches the recyclers 409. Consolidator 407 is able to provide tracking and accounting for the recycle materials to the waste generators 405 as to which of the specific recyclers the recycle material went to.

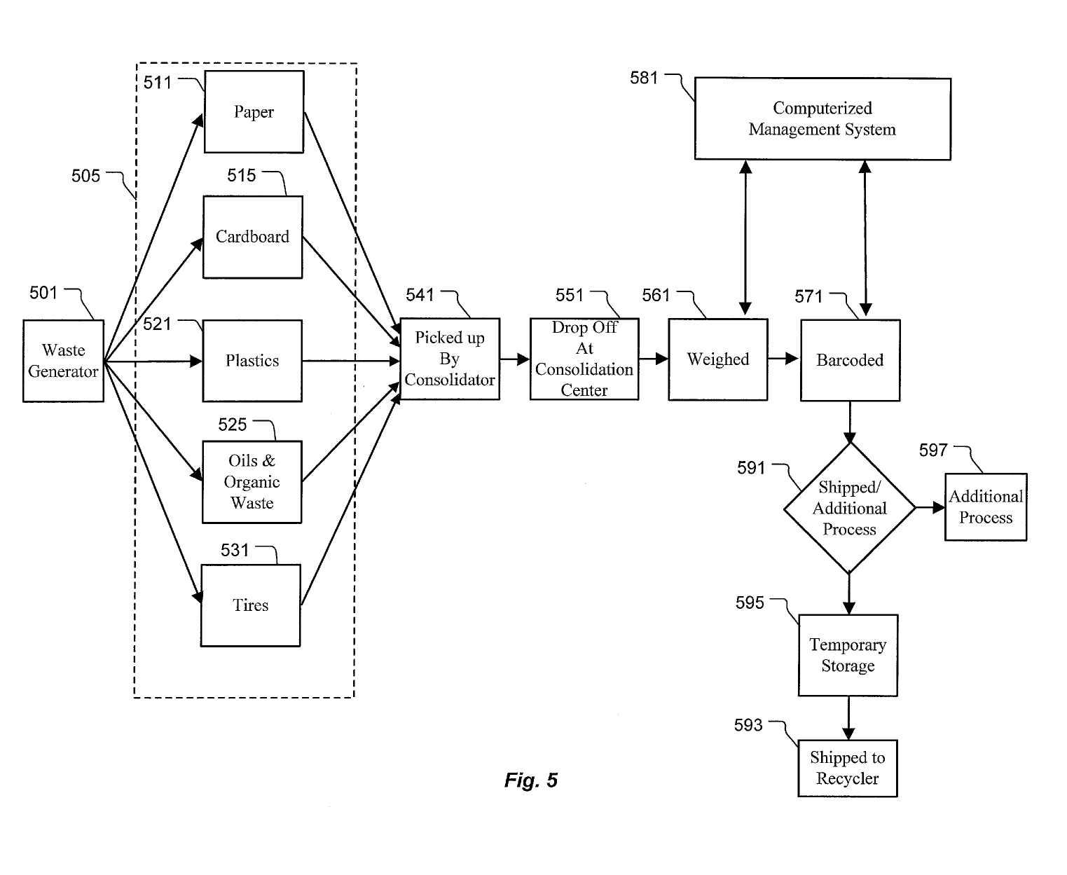

Referring now also to FIG. 5 in the drawings, a preferred embodiment of a system for life-cycle tracking of recycle commodities according to the present application is illustrated. Waste generator 501 generates a variety of recycle materials 505. In the preferred embodiment shown the recycle materials 505 are typical of a retailers waste. It should be apparent that other waste generators such as manufactures, distributors, hospitals, school, and government facilities would have other recycle materials in addition to or in place of those shown in FIG. 5 such as metal shavings, wooden dunnage, or cleaning solvents. One man's trash is another man treasure depending upon the circumstances. Recycle materials 505 are organized by the waste generator 501 into groups such as a paper 511, cardboard 515, plastics 521, oils & organic waste 525, and tires 531. These groups are determined by the value of the material. It should be understood that if all recycle materials were clumped together the value of the material would be less because of the additional processing required to sort the materials into separate groups. Additionally, it should be apparent that these groups are capable of being divided again so that one type of plastics say pill bottles are separated from the rest of the plastics to be recycled.

A single consolidator arrives at waste generator's facility and picks up 541 the load of recycle materials 505. Once at the consolidation facility the recycle materials 505 are dropped off 551. The process of dropping off the recycle materials 505 could further include determining whether the load of recycle materials should be unloaded at a loading door of a warehouse or in a yard of a warehouse. During unloading of the recycle materials 505 each parcel of recycle material is weighed 561 and tagged with a barcode 571. Preferably, the weight of the recycle material is tracked along with the weight of the container the recycle material is located in. The tare weight or the weight of the container is automatically determined by the type of recycle material being transported. The information tied to the barcode which is inputted into the computerized management system 581 includes the specific waste generator or specific location the recycle material originated from, the type of container the recycle material is stored in, the type of recycle material, and the weight. Once the information about the parcel of recycle material is entered into the computerized management system 581 the management system provides the attendant with a location to take the parcel.

The computerized management system 581 makes a decision 591 about whether the tagged parcel of recycle material should be shipped 593 or should be further processed 597. The variables that are inputs into the decision 591 comprise: the type of recycle material; whether there are additional processes that are possible before shipping; quantity of recycle materials on hand; room at consolidation center; availability of shipping method; cost effectiveness of shipping; or if there enough recycle material to fill a truck.

If the computerized management system 581 decides to ship the parcel of recycle material, the recycle material may need to be stored temporarily 595 in order to maximize the efficiency of shipping the recycle material to the recycler.

In the preferred embodiment assorted recyclers are co-tenants at the consolidation center. This reduces shipping costs for the waste generators. For example, a co-located recycler could further process the recycle material 597 such as stripping the insulation off of wiring. This further processing 597 is a nearly closed cycle such that the plastic stripped off the wiring would be allocated to the waste generator in addition to the copper. While processing recycle materials there will likely be some small amount of loss. However since the recycle materials are weighed before the processing 597 a proper accounting can be provided to the waste generator. In an alternative embodiment the consolidation center is merely a pass-through hub where the recycle materials are temporarily staged until shipped to the recyclers.

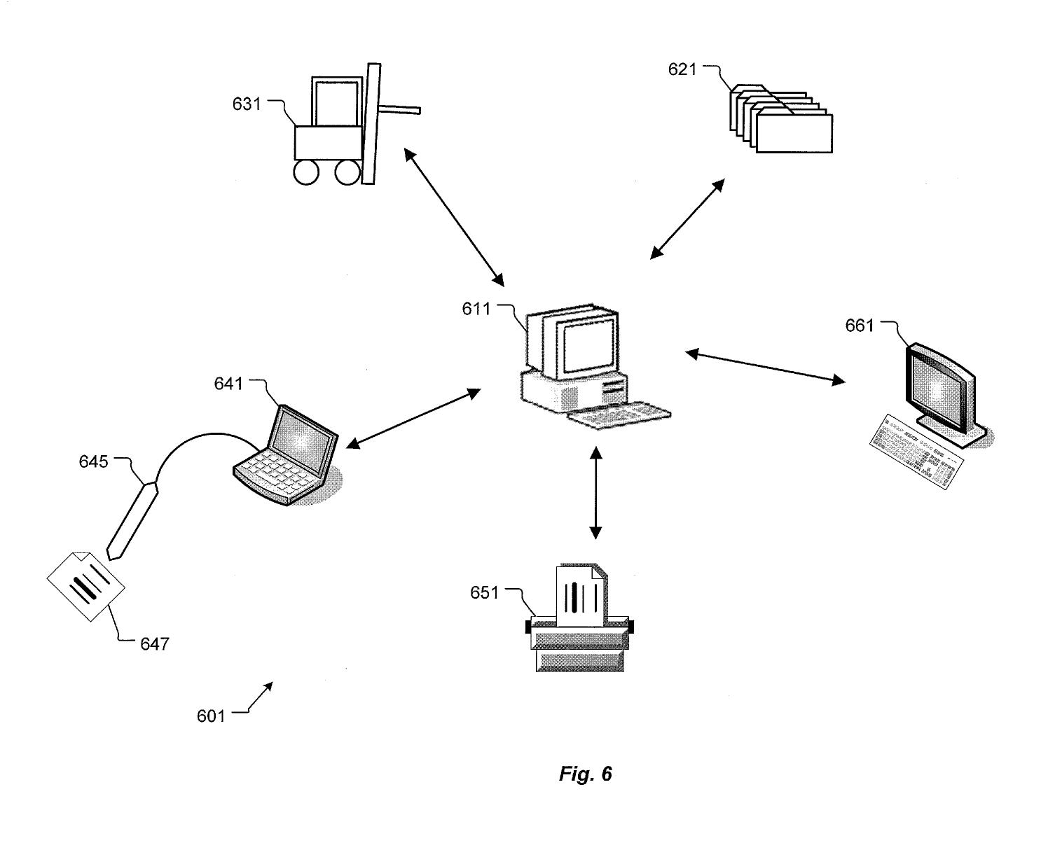

Referring now also to FIG. 6 in the drawings, an embodiment of a management system according to the present application is illustrated. The computerized management system 601 may include local computers, remote computers, barcode readers, barcode printers, databases, programmable logic controllers, trade legal scales capable of providing certified trade weights, wired computer networks, wireless computer networks, globally networked computers, internet switches, hubs, digital storage mediums or computer-readable storage mediums, local area networks, wide area networks. Preferable the computerized management system 601 includes a networked computer 611, a database stored on computer-readable storage mediums 621, forklifts with trade legal scales 631, local computer 641 with a barcode reader 645, a preprinted form with barcodes corresponding to types of recycle material 647, a barcode printer 651, and a remote computer 661. In an alternative embodiment the computerized management system 601 includes processors capable of processing the data and transforming the data between the networked computer 611 and the remote computer 661. It should be understood that the computerized management system 601 could be as small as a single computer or preferably a large scale multi-enterprise system with networked computers spanning across multiple locations and multiple companies. Local computer 641 could be a single unit mounted near a dock door or could be a multitude of computers networked together with units near every dock door. Additionally, the local computer 641 could be located on a fork lift or wearable by an employee of the consolidator. Barcode printer 651 preferably creates standard barcodes, however the barcode printer 651 in an alternative embodiment creates any variety of barcodes such as Q-codes. The important feature is the ability to track recycle material on a per item basis by giving each parcel a unique identifier or serial number capable of being tracked. In an alternative embodiment the tracking information could be tied to a radio frequency identification device or RFID. Another embodiment could have the system utilize an existing RFID tag located in the parcel if one existed. For example many devices have RFID tags located in them and when thrown away the RFID tags are still operative. The system can detect those old RFID tags and take one or several of them combined to give the parcel a unique identifier in the system.

The software that is located on the networked computer 611 has a role-based software security model. Based upon the role the software user has enables the software to only display certain aspects of the database. For example waste generator A is able to real-time track the status of all the materials that have been picked up from waste generator A. Waste generator A is not able to see the status of recycle materials for waste generator B, and vice versa. Additionally, for example a dock worker using the barcode reader 645 and local computer 641 would only see aspects of the database that are relevant to the dock worker. The software is capable of providing users with textual information as well as graphical information related to the recycle materials location, quantity, length of time at location, etc. Additionally, the software is capable of providing an accounting of the recycle materials to the users.

Remote computer 661 is located at the waste generator's location of choice and enables the waste generator access to the database. The software may be locally run on the remote 661 as in it is installed on the remote computer 661 local memory. Preferably, the software is stored on networked computer 611 and merely accessed by remote computer 661. For example the software the waste generator accesses could be an online portal accessed through the internet. In an alternative embodiment the data connection between the remote computer 661 and the networked computer 611 is an isolated direct connection. Remote computer 661 provides the waste generator with instantaneous information related to the condition of the recycle material the consolidator picked up from the waste generator. The waste generator is able to track down to the parcel where recycle materials were picked up, where they went, and all steps along the way. The waste generator does not have to wait for an arbitrary period of time for the system to update the status of the recycle material. As soon as the dock operator tags a parcel of recycle material at the dock door the management system through the remote computer provides the waste generator with the status. The immediacy of the information provided to the waste generator enables the waste generator to make and track subtle changes to their recycle programs on a local, regional, and national level and be able to real-time see the effect of those changes.

Providing life-cycle tracking of the recycle materials is critical to waste generators considering the large amounts of revenue the recycle materials are worth. This could also include environmental credits or rebates from governments. Being able to track and monitor recycle materials on a per parcel or per bail basis gives the waste generator the power to map out implementation of recycling programs. Tracking allows waste generators to determine locations that are not matching the recycle material output of similar locations. Recycle material generation can be tracked by peak times and periods. Providing real time tracking information to the waste generators allows waste generators to determine how effective recycling programs within day of implementation instead of having to wait months with the current systems. The system provides waste stream inventory to the waste generators approaching the level of sophistication they have with their own suppliers.

It is apparent that a system with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. A system for life-cycle tracking of recycle commodities, comprising:
a waste generator system, having recycle materials,
wherein the waste generator system separates the recycle materials and generates bundles of recycle materials;
a consolidator system, having a forklift with a trade legal scale;
wherein the consolidator system removes the bundles of recycle materials from the waste generator, weighs the bundles of recycle materials, and tracks the bundles of recycle materials;
a recycler that purchases the bundles of recycle materials directly from the waste generator system and recycles the bundles of recycle materials; and
a computerized management system that allows for the waste generator system to account for and track the bundles of recycle material removed by the consolidator system and recycled by the recycler.

2. The system for life-cycle tracking of recycle commodities according to claim 1, wherein the computerized management system comprises:
a global based network of computers; and
a role-based tracking and accounting software system for providing real-time tracking and accounting of the bundles of recycle materials located on the global based network of computers.

3. The system for life-cycle tracking of recycle commodities according to claim 2, wherein the computerized management system further comprises:
a first computer in networked communication with the network of computers, the first computer being operated by the consolidator having a barcode reader for categorizing the bundles of recycle materials and a barcode printer for assigning a unique identifier to the bundles of recycle material;
a second computer in networked communication with the network of computers, the second computer being operated by the consolidator system for computing and storing selected accounting and tracking information pertaining to the bundles of recycle material; and
a third computer in networked communication with the network of computers, the third computer being operated by the waste generator system for accessing the accounting and tracking information stored in the second computer.

4. A system for life-cycle tracking of recycle materials, comprising:
parcels of recycle materials;
a trade legal scale for weighing the parcels of recycle materials; and
a plurality of networked computers for tracking the parcels of recycle materials.

5. The system for life-cycle tracking of recycle materials according to claim 4, wherein the plurality of networked computers comprises:
a first computer having a barcode reader for categorizing the parcels of recycle material and a barcode printer for uniquely identifying the parcels of recycle materials;
a second computer programmed with an accounting and tracking software package for individualized accounting and tracking of the parcels of recycle materials; and
a third computer having remote access to the accounting and tracking of the parcels of recycle materials.

6. The system for life-cycle tracking of recycle materials according to claim 5, wherein the trade legal scale is located on a fork lift and is in communication with the plurality of networked computers.

7. A method for life-cycle tracking of recycle materials, comprising:
sorting parcels of recycle materials by a waste generator;
grouping the parcels of recycle materials by the waste generator;
consolidating the parcels of recycle materials by a consolidator;
tracking the parcels of recycle materials by the consolidator by use of a computerized management system; and
purchasing the parcels of recycle materials by a recycler directly from the waster generator.

8. The method for life-cycle tracking of recycle materials according to claim 7, wherein the computerized management system comprises:
a plurality of networked computers;
a certified trade legal scale;
tracking software for tracking the parcels of recycle materials; and
a printer for assigning a unique identifier to each parcel of recycle materials for accounting and tracking purposes;
wherein the printer in conjunction with the networked computers and the tracking software is for serializing the parcels of recycle material.

9. The method for life-cycle tracking of recycle materials according to claim 8, wherein the plurality of networked computers comprises:
a first computer in communication with a barcode reader and the printer;
a second computer in communication with the first computer and the tracking software for individualized tracking and accounting of the parcels of recycle materials; and
a third computer in communication with the second computer and the tracking software for providing tracking information of the parcels of recycle materials.

10. The method for life-cycle tracking of recycle materials according to claim 8, wherein the certified trade legal scale is located on a forklift and is in communication with the networked computers and the tracking software.

11. The method for life-cycle tracking of recycle materials according to claim 8, wherein the tracking software comprises:
a role-based interface for limiting access to the tracking of the parcels of recycle materials based upon a user's role.
